(19) United States
(12) Patent Application Publication
(10) Pub. No.: US 2010/0050576 A1
(43) Pub. Date: Mar. 4, 2010

(54) CLOSING ELEMENT FOR A RECEPTACLE, PARTICULARLY A GLASS BEVERAGE BOTTLE, AND CLOSING METHOD USING THE SAME

(76) Inventor: Lutz Möller, Monheim (DE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/516,367

(22) PCT Filed: Nov. 19, 2007
(86) PCT No.: PCT/EP07/62515

§ 371 Date: May 27, 2009

(30) Foreign Application Priority Data
Nov. 27, 2006 (DE) 10 2006 056 187.2

(51) Int. Cl. B67B 3/20; B65D 41/00; B65D 39/00; B65D 41/04; B67B 3/02

(52) U.S. Cl. 53/490; 215/316; 215/355; 215/329; 53/485

(57) ABSTRACT

The invention relates to a closing element for a receptacle, such as a glass beverage bottle, comprising a plug and a retaining element that is connected to the plug, as well as a method for closing an opening of a receptacle by means of a closing element comprising a plug and a retaining element. In order to devise a closing element and a closing method that provide a great degree of reliability, storage quality, and food compatibility, the plug is made of a solid material such as glass, ceramics, wood, metal, aluminum, stone, or silicon. Furthermore, in the closed state of the receptacle, the plug rests within a receptacle opening that is to be closed, or the plug made of the solid material is fully inserted into the receptacle opening to close the receptacle, and a connecting element is created between the plug and the retaining element such as by means of an adhesive, the retaining element being releasably connected to the receptacle.

### CROSS REFERENCE TO RELATED APPLICATION

This application claims the priority benefits of International Application No. PCT/EP2007/062515, filed on Nov. 19, 2007, which is hereby incorporated herein by reference in its entirety.

### BACKGROUND OF THE INVENTION

The invention relates to a closure element for a receptacle, in particular a glass beverage bottle.

The invention also relates to a method of closing an opening in a receptacle, in particular a glass beverage bottle.

The German laid-open document DE 41 19 440 A1 discloses a closure cap for a bottle. In a typical manner, an opening in the bottle provided at the end of a neck part—defined also as the mouthpiece—can be releasably closed by means of this closure cap. The closure cap is in the form of a lid and consists accordingly of a cover plate and an adjoining collar. In this case, the cover plate has an outer diameter which is greater than the outer diameter of the neck part of the bottle, and starting from the cover plate the collar of the closure cap protrudes from the outside over the neck part and is releasably locked thereto. A thread may be provided for this purpose on the outer side of the neck part and a corresponding counter thread is provided on the inner side of the collar of the closure cap. Disposed on the inner side of the cover plate is a first ring-like seal which lies sealingly against the inner surface of the neck part when the bottle is in the closed condition, and a second ring-like seal is provided which, in the closed condition, lies sealingly against the end-face end of the neck part of the bottle. This type of design of the sealing surfaces of the closure cap is intended to permit automatic ventilation in dependence upon the internal pressure building up in the bottle irrespective of the outside temperature.

Furthermore, the German utility model DE 93 15 073 U1 discloses a solid glass stopper for closing a glass laboratory vessel. The stopper consists substantially of a handle portion and an adjoining shaft. The shaft is formed in a tapered or conical manner and comprises a so-called core grinding which in order to close the laboratory vessel can be moved sealingly into engagement with a further ground area in the opening region of the laboratory vessel. The shaft may have a tip in the form of a spherical segment which in conjunction with the solid design of the glass stopper is intended to displace the air from the opening region of the laboratory vessel in a particularly effective manner during closing of said laboratory vessel. It is also known to form such solid stoppers so as to be hollow.

Furthermore, the German laid-open document DE 103 31 821 A1 discloses a glass stopper for closing bottles, in particular wine or sparkling wine bottles. The glass stopper comprises a head part and a support surface for a seal. By means of a hardening procedure performed during production of the stopper, the intention is to provide an increased degree of ruggedness to withstand mechanical damage from the time the stopper is produced in the glass press until it is returned in a glass container for recyclable glass.

U.S. Pat. No. 1,218,662 A already discloses a closure element for the opening of a bottle neck, which comprises a stopper and a grip part. In the delivery condition of the bottle, the closure element is inserted into the bottle neck in such a manner that the grip part protrudes into the bottle neck and the stopper terminates approximately flush with the bottle neck. In addition, the stopper is secured in the bottle neck by a retaining element in the form of a cap. In this case, the retaining element lies loosely against the stopper. In addition, the retaining element is sealed with respect to the outer side of the bottle neck by means of a circumferential seal. To open the bottle, the retaining element is removed, the stopper with the grip part still remains in the bottle neck when the retaining element is being removed. The retaining element and the stopper are not connected to one another but lie loosely against one another. In order finally to open the bottle, the stopper with the grip part has to be removed from the bottle. For this purpose, the stopper comprises on its side remote from the grip part a web, by which the stopper with the grip part can be pulled out of the bottle neck. In order to re-close the bottle neck, the stopper is rotated so that the grip part protrudes upwardly out of the bottle and this makes it easier to open and close the bottle repeatedly. The stopper with the grip part is produced from glass or a glass-like material.

It is also generally known that bottles used for supplying beverages to end-consumers are closed by means of crown corks, stoppers, corks or screw caps. Small glass bottles are typically closed by means of a synthetic material element. In many embodiments, these closure elements comprise a sealing element made of deformable synthetic or natural material. The sealing function of the sealing element is based upon the deformability thereof. With regard to the synthetic materials, this deformability is achieved substantially by the presence of plasticizers in the respective synthetic material. In technical literature, the plasticizers and their constituents are ascribed a toxic and allergenic effect and the ability to migrate into liquids and thus also into beverages in a bottle. This also applies to glass stoppers having a sealing ring made of synthetic material. Moreover, glass stoppers which do not have synthetic material seals are particularly sensitive to mechanical loads during transportation. Therefore, they are used primarily in the laboratory and are not very suitable for large scale consumer supply.

### SUMMARY OF THE INVENTION

The present invention provides a closure element for a receptacle, in particular a glass beverage bottle and a closing method using the same, which demonstrates a high degree of reliability, durability and food compatibility.

In accordance with an aspect of the invention, in the case of a closure element for a receptacle, in particular a glass beverage bottle, consisting of a stopper and a retaining element which is allocated to the stopper and which is releasably connected to the receptacle, wherein the stopper is produced from a solid material and when the receptacle is in the closed condition the stopper rests inside an opening in the receptacle which is to be closed, when the receptacle is in the closed condition the stopper is held in the opening by the retaining element and the retaining element is formed in the manner of a cap having a base plate and a ring which adjoins the base plate. A high degree of reliability, durability and food compatibility is achieved by virtue of the fact that the retaining element is connected to the stopper by a connection element. By virtue of the stopper in accordance with the invention, it is possible to limit the contact of the contents of the bottle to the solid material of the stopper and to the receptacle material. Typically used synthetic materials are not utilised. The risk potential caused by impurities from the synthetic materials is reduced effectively. Therefore, this stopper can also be used for the closure of beverage bottles, in particular bottles of table water, without plasticizers dissolving as a result of the direct contact of a sealing surface consisting of synthetic material. It is therefore suitable for large-scale consumer supply.

The stopper may be made of glass, ceramic, wood, metal, aluminium, stone or silicon, for example.

Moreover, the stopper can be protected in an optimal manner by virtue of the fact that when the receptacle is in the closed condition the stopper rests completely in a channel which adjoins the opening. When the receptacle is in the closed condition, the outwardly directed surface of the stopper may adjoin in a flush manner an end of the receptacle which is adjacent to the opening. In this case, the stopper does not protrude from the opening.

The reliability and thus sealing-tightness of the closure element are enhanced by virtue of the fact that when the receptacle is in the closed condition the stopper is held in the opening by the retaining element and the retaining element is connected to the stopper by a connection element.

An adhesive may be used as a connection element. The adhesive is able to transmit a sufficiently large force in order also to remove the stopper from the opening in the bottle by releasing the retaining element. The connection element may be elastic so that forces which are exerted from the outside upon the retaining part are transmitted merely in a damped manner to the stopper.

In a known manner, the retaining element can be formed in the manner of a cap having a base plate and a ring which adjoins the base plate. The connection element is then disposed between the base plate and the stopper.

The connection element may be disposed in the edge region of the stopper. In this region, the retaining element is more stable than in the middle and thus, in turn, any forces which are exerted from the outside upon the retaining part are transmitted merely in a damped manner to the stopper, as these forces are introduced into the neck part of the bottle.

In addition, the hollow space remaining next to the connection element and between the base plate and the stopper can serve to protect the stopper.

Closing and opening the bottle without damaging the stopper can be facilitated by virtue of the fact that the retaining element may be formed as a twist closure with an internal thread disposed on the retaining element and an external thread disposed on a neck part of the receptacle.

In a further embodiment, it is provided that a bore is disposed centrally in the base plate and a sealing adhesive connects the stopper, the retaining element and the neck part at least partially to one another via the bore. The sealing adhesive renders it possible to secure the closure element in a convenient manner and can be formed in an aesthetically pleasing manner.

In an advantageous manner, the topside of the stopper facing the retaining element is roughened. The adhesive can thus adhere to it better.

A glass stopper in combination with a glass bottle obviates contamination of the contents of the bottle by plasticizers otherwise contained in seals or bottles.

In accordance with another aspect of the invention, in the case of a method of closing an opening in a receptacle, in particular a glass beverage bottle, with a closure element which comprises a stopper and a retaining element, in which in a first step the stopper consisting of a solid material, such as glass, ceramic, wood, metal, aluminium, stone or silicon, is inserted completely into the opening in the receptacle in order to close it, and in a further step the stopper resting in the opening is covered by a retaining element which is releasably attached to the receptacle, a high degree of reliability, durability and food compatibility is achieved by the following step:
producing a connection element by means of an adhesive between the stopper and the retaining element, after the stopper has been inserted into the opening.

An adhesive may be selected that only hardens after closure of the bottle, so that it is possible to prevent the stopper from being damaged during mounting.

In accordance with another aspect of the invention, in the case of a method of closing an opening in a receptacle, in particular a glass beverage bottle, with a closure element which comprises a stopper and a retaining element, in which in a first step the stopper consisting of a solid material is inserted completely into the opening in the receptacle in order to close it, and in a further step the stopper resting in the opening is covered by a retaining element which is releasably attached to the receptacle, a high degree of reliability, durability and food compatibility is also achieved by the following steps:
fixing the stopper to the retaining element by means of a connection element in the form of an adhesive,
closing the receptacle with the closure element, and
subsequently hardening the adhesive.

This also makes the mounting procedure easier.

These and other objects, advantages and features of this invention will become apparent upon review of the following specification in conjunction with the drawings.

### BRIEF DESCRIPTION OF THE DRAWINGS

FIG. 1 is a side sectional view of a neck part of a bottle having an opening which is closed with a closure element in accordance with the present invention; and

FIG. 2 is a side sectional view of the neck part of FIG. 1 having another closure element.

### DESCRIPTION OF THE PREFERRED EMBODIMENT

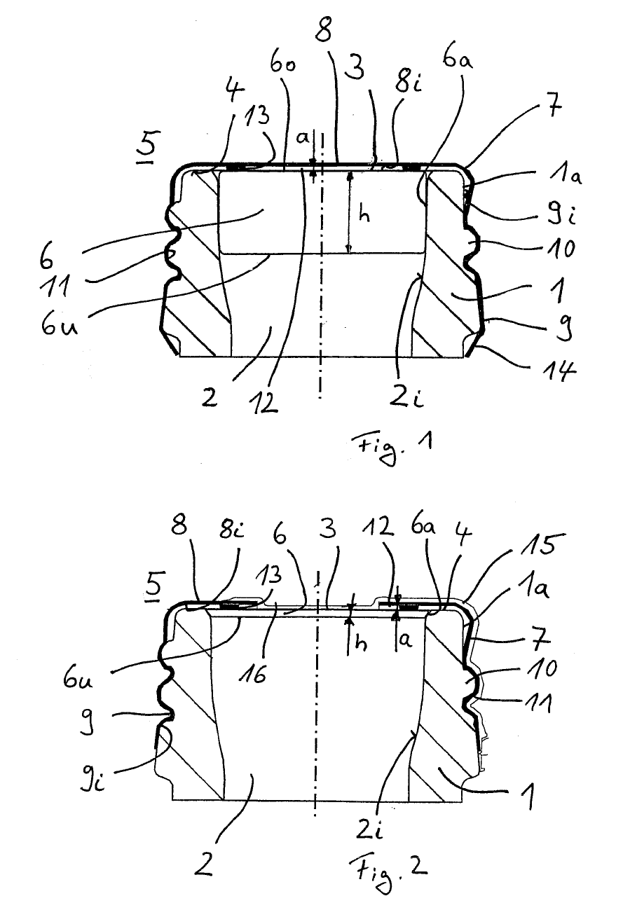

FIG. 1 illustrates a cross-section through the top end of a neck part 1 of a bottle, not illustrated. The neck part 1, which is typically hollow and tapers starting from the remainder of the bottle, has a central conical channel 2 which issues into an opening 3 at the end-face end 4 of the neck part 1. This, opening 3 is closed with a closure element 5 which is formed in FIG. 1 in a first embodiment.

The closure element 5 consists substantially of a stopper 6 and a retaining element 7. The stopper 6 is in the form of a circular disk with a height h of 0.5 mm to 15 mm. For example, the height may be less than 11 mm, less than 5 mm or less than 1 mm. The thin embodiment of the stopper 6 which is illustrated in FIG. 2 has a height of about 0.75 mm. In the exemplified embodiment illustrated in FIG. 1, the stopper 6 has a height of about 8 mm.

The materials which can be selected for the stopper 6 include glass, ceramic, wood, metal, aluminium, stone, silicon and similarly solid materials. Glass, in particular thermally hardened glass, may be used. The top side 6o of the stopper 6 is planar or concave, its bottom side 6u is planar, convex or concave in formation. Moreover, the material of the stopper 6 may be identical to the material of the bottle. Furthermore, the material of the stopper 6 can be adapted to the material of the bottle in such a manner that the stopper conforms to the expansion behaviour of the neck part 1 during a change in temperature such that a temperature-controlled build-up of pressure between the stopper 6 and the neck part 1 is minimised.

In order to close the bottle, the stopper 6 is typically inserted into the opening 3 and thus into the channel 2. For this purpose, the shape of the stopper 6 and thus its outer surface 6a are adapted to the inner surface 2i of the channel 2. FIG. 1 illustrates the stopper 6 in its seal seat. In this case, the stopper 6 does not protrude outwardly over the end 4 of the neck part 1 and at most terminates flush with the end 4 of the neck part 1.

In the region of its outer surface 6a, the rotationally symmetrical stopper 6 is formed in a tapered or conical manner. This outer surface 6a is in sealing engagement with the inner surface 2i of the channel 2 in the neck part 1. Moreover, the outer surface 6a of the stopper 6 may comprise a fine roughness in order to limit the direct adhesion to the inner surface 2i. This roughness may be produced by grinding, etching or laser-thermal methods. The edges of the stopper 6 may also be ground, with a phase, with a radius or with a combination of the aforementioned variations.

In addition, the channel 2 of the neck part 1 is provided with a sealing surface which corresponds to the formation of the outer surface 6a of the stopper 6. The inner surface 2i of the channel 2 may be machined by means of a rotating laser beam or by grinding, for example.

In one embodiment of the stopper 6, the outer surface 6a of the stopper 6 is minimised in its function as a sealing surface to the extent that the exit of liquids continues to be prevented but the passage of gas molecules is permitted.

In order to hold the stopper 6 securely in its seal seat, the retaining element 7 is provided as a further component of the closure element 5. The retaining element 7 is formed as a cap and consists substantially of a base plate 8 and a ring 9. Corresponding to the outer contour of the end 4 of the neck part 1, the base plate 8 is a disk which is adjoined by the ring 9 via a curve. The retaining element 7 and thus the base plate 8 are releasably attached to the neck part 1 via the ring 9. The retaining element 7 may be produced from aluminium, for example; it can also be made of synthetic material.

In the present exemplified embodiment, the closure element 5 is formed, as a twist closure. Accordingly, the neck part 1 comprises on its outer peripheral surface 1a a circumferential external thread 10 and the ring 9 of the closure element 5 comprises on its inner peripheral surface 9i an internal thread 11. When the bottle is in the closed condition, the base plate 8 of the closure element 5 is minimally spaced apart by a spacing a from the topside 6o of the stopper 6. Therefore, a hollow space 12 is created between the topside 6o of the stopper 6 and the inner side 8i of the base plate 8 of the closure element 5. Therefore, to a limited extent the closure element 5 can absorb any impact loadings and thus protect the stopper 6.

Moreover, the inner side 8i of the base plate 8 facing towards the stopper 6 is connected to the stopper 6 via connection elements 13. The connection element 13 may be an adhesive, with which the hollow space 12 is at least partially filled. The stopper 6 is thus connected elastically to the base plate 8 of the connection element 5. FIG. 1 illustrates an annular adhesive bead. The connection element 13 is selected such that during opening of the bottle the release forces are reliably transmitted from the closure element 5 to the stopper 6 and the stopper 6 is thus removed in a reliable manner from the opening 3.

The adhesive connection between the stopper 6 and the retaining element 7 is optionally established only upon closure of the bottle. In a first step, the bottle is closed with the stopper 6, adhesive is then applied to the inner side 8i of the base plate 8 of the closure element 5 and subsequently the retaining element 7 is screwed on or pressed on. In one embodiment, the closure element 5 is integrally formed in a positive-locking manner on the outer peripheral surface 1a of the neck part 1 by means of plastic deformation. However, in this case no mechanical pressure is applied to the stopper 6. The adhesive achieves its ultimate strength immediately upon closure of the bottle. This is triggered or assisted by an adapted pot life of the adhesive or by the activation of its solidification by means of light, heat or vibrations.

Alternatively, it is possible to glue the stopper 6 into the retaining element 7, wherein the adhesive is then not yet hardened. The retaining element 7 is then screwed on or pressed on, the stopper 6 thus moves to its seal seat and the adhesive then hardens in the manner described above.

The adhesive may be applied in the edge region of the stopper 6 or the base plate 8 of the closure element 5, so that mechanical forces on the centre of the base plate 8 are not transmitted directly from the adhesive to the stopper 6, but rather the transmission of forces is limited to the particularly stable edge region of the base plate 8. The topside 6o of the stopper 6 is also provided with a roughness that provides improved grip for the adhesive.

The adhesive can also be selected such that for recycling purposes, the stopper 6 consisting glass can then be detached from the retaining element 7, e.g. an adhesive may be used which dissolves when heated and/or in lyes.

In addition, a retaining ring 14, by means of which the closure element 5 is secured in a typical manner on the neck part 1, is attached to the end of the ring 9 remote from the base plate 8. When the closure element 5 is opened as required, the retaining ring 14 is broken open. The retaining ring 14 thus has the function of an originality feature.

Also, according to discretion it is possible to design the stopper 6 to be clear or coloured, to provide it with patterns on one or several surfaces or on the interior. A combination of patterns and colour can then serve as a coding or originality feature.

FIG. 2 illustrates a cross-section, corresponding to FIG. 1, with a closure element 5 according to a second embodiment. The basic structure of the closure element 5 corresponds to the structure previously described, so that reference is made to this particular description. The essential difference resides in the use of a sealing adhesive 15, in order that when the bottle is in the closed position the neck part 7 is protected from being opened without this being recognised and this serves as proof of originality. The stopper 6 also has a lower height h than the stopper shown in. FIG. 1.

In order to secure the closure element 5 using the sealing adhesive 15, the base plate 8 comprises a central bore 16 and the ring 9 is shorter than the ring shown in FIG. 1. The sealing adhesive 15 can thus be introduced into the bore 16 and thus onto the topside 6o of the stopper 6 and the adjacent inner edge of the base plate 8. From this point, the sealing adhesive 15 extends at least partially over the base plate 8 and the adjacent ring 9, until the outer peripheral surface 1a of the neck part 1 is reached. After solidification of the sealing adhesive 15, the neck part 7 is thus secured in the desired manner. By impressing a signature or a graphic onto the sealing adhesive 15, it can be more difficult to reproduce the seal or a definable yield line can be prepared which would show evidence of any re-closure. Moreover, by impressing a signature or graphic a yield line can be induced which by means of downwardly directed teeth prevents the seal from being reproduced.

In the exemplified embodiments above, the closure element 5 is described in conjunction with a bottle. However, this closure element 5 is also suitable for closing other receptacles such as e.g. small bottles. The closure element 5 can also be formed as a crown cork. In all cases, the closure element 5 is connected in a positive-locking manner to the receptacle, in particular the neck part 1 of a bottle.

Changes and modifications in the specifically, described embodiments can be carried out without departing from the principles of the present invention, which is intended to be limited only by the scope of the appended claims, as interpreted according to the principles of patent law including the doctrine of equivalents.

1. A closure element for closing a glass beverage bottle, the bottle having an opening and a channel that adjoins the opening, said closure element comprising:
a stopper comprising a solid material chosen from glass, ceramic, wood, metal, aluminum, stone, and silicon, said stopper being in the form of a round disk with a height of less than 5 mm;
a retaining element formed in the manner of a cap comprising a base plate, a ring that adjoins the base plate, and an elastic connection element, said connection element coupling said retaining element to the stopper and said retaining element being releasably connectable to the bottle; and
wherein said stopper is adapted to rest inside the opening and completely in the channel and is held in the opening by said retaining element.

2. The closure element as claimed in claim 1, said stopper comprising an outwardly directed surface, wherein when the bottle is closed, said outwardly directed surface of said stopper adjoins in a flush manner an end of the bottle which is adjacent to the opening.

3. The closure element as claimed in claim 2, wherein said stopper comprises a cross-section which corresponds to the opening.

4. (canceled)

5. (canceled)

6. The closure element as claimed in claim 3, wherein said stopper is in the form of a round disk with a height of less than 1 mm.

7. The closure element as claimed in claim 1, wherein said connection element is an adhesive.

8. The closure element as claimed in claim 1, wherein said connection element is disposed between said base plate and said stopper.

9. The closure element as claimed in claim 8, said stopper comprising an edge region, wherein said connection element is disposed at said edge region of said stopper.

10. The closure element as claimed in claim 1, comprising a hollow space next to said connection element and between said base plate and said stopper.

11. The closure element as claimed in claim 1, wherein the bottle comprises a neck and an external thread disposed on the neck, and wherein said retaining element comprises an internal thread at said ring for engaging the external thread to provide a twist closure for the bottle.

12. The closure element as claimed in claim 11, comprising a bore disposed centrally in the base plate and a sealing adhesive at said bore for connecting said stopper, said retaining element, and the neck part of the bottle at least partially to one another.

13. The closure element as claimed in claim 1, said stopper comprising an outwardly directed surface facing towards said retaining element, wherein said outwardly directed surface is roughened.

14. The closure element as claimed in claim 1, wherein said stopper is made of glass.

15. A method of closing an opening in a glass beverage bottle, said method comprising:
providing a closure element which comprises a retaining element and a stopper, the stopper made of a solid material chosen from glass, ceramic, wood, metal, aluminum, stone, and silicon;
fixing the stopper to the retaining element by means of a connection element, in the form of an adhesive, to cover the stopper with the retaining element;
closing the bottle with the closure element including releasably attaching the retaining element to the bottle while inserting the stopper completely into the opening of the bottle; and
subsequently hardening the adhesive.

16. The method as claimed in claim 15, wherein said releasably attaching the retaining element to the bottle comprises twisting the retaining element relative to the bottle.

17. The closure element as claimed in claim 1, wherein said stopper comprises a cross-section which corresponds to the opening.

18. A closure element for closing a glass beverage bottle, the bottle having an opening and a channel that adjoins the opening, said closure element comprising:
a stopper comprising a solid material chosen from glass, ceramic, wood, metal, aluminum, stone, and silicon, said stopper being in the form of a round disk with a height of less than 5 mm;
a retaining element formed in the manner of a cap comprising a base plate, a ring that adjoins the base plate, and an elastic connection element, said connection element coupling said retaining element to the stopper and said retaining element being releasably connectable to the bottle; and
wherein said stopper is adapted to rest inside the opening and completely in the channel and is held in the opening by said retaining element.

19. (canceled)

20. The closure element as claimed in claim 18, wherein said stopper is in the form of a round disk with a height of less than 1 mm.
